(19) United States
(12) Patent Application Publication
(10) Pub. No.: US 2016/0224590 A1
(43) Pub. Date: Aug. 4, 2016

(54) TRANSFER OF DIGITAL MEDIA OBJECTS VIA MIGRATION

(71) Applicant: ReDigi, Inc., Boston, MA (US)

(72) Inventors: Lawrence S. Rogel, Brookline, MA (US); John M. Ossenmacher, Balboa Island, CA (US)

(21) Appl. No.: 14/822,304

(22) Filed: Aug. 10, 2015

Related U.S. Application Data
(63) Continuation of application No. 13/836,683, filed on Mar. 15, 2013, now abandoned.
(60) Provisional application No. 61/710,008, filed on Oct. 5, 2012.
(60) Provisional application No. 61/678,607, filed on Aug. 1, 2012.

(51) Int. Cl. G06F 17/30; H04L 29/08

(52) U.S. Cl. CPC G06F 17/30168; G06F 17/30079; H04L 67/06

(57) ABSTRACT

The invention provides in some aspects an improved method for transfer of digital media objects that includes storing a digital file on a first digital data device and migrating that digital file to a second digital data device by repeating a plurality of times the steps of: (i) transferring to a second digital data a respective piece of the digital file, (ii) storing that respective piece of the digital file on the second digital data device. The foregoing are effected so that no respective piece of the digital file is concurrently stored on the first and second digital data devices and/or, more generally, so that any same portion of the digital file that is concurrently stored on the first and second digital data devices comprises not more than an insubstantial amount of the digital data file. Methods and apparatus according to the invention can be used for the (re)sale, lending, streaming or other transfer of digital music, digital books and other digital media objects.

This claims the benefit of filing of U.S. Patent Application Ser. Nos. 61/710,008 filed Oct. 5, 2012, entitled “Transfer of Digital Media Objects Via Migration, Application” and No. 61/678,607, filed Aug. 1, 2012, entitled “File Migration without Copying,” the teachings of all which are incorporated herein by reference.

### BACKGROUND OF THE INVENTION

The invention pertains to digital media handling and, more particularly, for example, to the transfer of digital media objects, e.g., digital files embodying creative works. The invention has application, by way of non-limiting example, in the (re)sale, lending, streaming or other transfer of digital music, digital books and other digital media objects.

U.S. patent application Ser. No. 13/406,237 and corresponding PCT Patent Application Serial No. PCT/US2012/026,776 (now, Publication No. WO 2012/116365), the teachings of all of which are incorporated by reference herein, disclose inter alia methods, apparatus and systems suitable for the (re)sale or other transfer of digital media objects which methods and apparatus include, inter alia, atomically transferring ownership of those objects so that at no instant in time are copies of them available to both buyer and seller—but, rather, may be available only to the seller prior to sale and only to the buyer after sale. While those techniques are effective, e.g., for the (re)sale, lending, streaming or other transfer of digital media objects, further improvements are desirable as to movement of the digital media objects between the computers or other digital data devices of buyers, sellers, etc.

An object of this invention is to provide improved methods, apparatus and systems for digital data.

A related object is to provide such methods, apparatus and systems as are suitable for digital media handling.

Another object is to provide such methods, apparatus and systems as facilitate the (re)sale, lending, streaming or other transfer of digital music, digital books and other digital media objects.

Yet still further aspects of the invention is to provide such methods, apparatus and systems as facilitate transfer of digital music, digital books and/or other digital media objects between computers and other digital data devices.

### SUMMARY OF THE INVENTION

The foregoing are among the objects attained by the invention, which provides in some aspects improved methods for transfer of digital media objects that includes storing a digital file on a first digital data device and migrating that digital file to a second digital data device by repeating a plurality of times the steps of: (i) transferring to the second digital data a respective piece of the digital file, (ii) storing that respective piece of the digital file on the second digital data device. The foregoing are effected, for example, so that no respective piece of the digital file is concurrently stored on the first and second digital data devices and/or, more generally, so that any same portion of the digital file that is concurrently stored on the first and second digital data devices comprises not more than an insubstantial amount of the digital data file—or, in related aspects of the invention, so that not more than an insubstantial amount of a creative work embodied in the digital data file is embodied in portions of the digital file that are concurrently stored on those devices.

Further aspects of the invention provide a method for transfer of digital media objects, e.g., as described above, in which the respective pieces of the digital file are sized to insure that no respective piece of the digital file is concurrently stored on the first and second digital data devices and/or, more generally, so that any same portion of the digital file that is concurrently stored on the first and second digital data devices comprises not more than an insubstantial amount of the digital data file—or, in related aspects of the invention, so that not more than an insubstantial amount of a creative work embodied in the digital data file is embodied in portions of the digital file that are concurrently stored on those devices.

Further aspects of the invention provide a method for transfer of digital media objects, e.g., as described above, in which the transferring step includes transferring pieces of the digital file not greater than a byte in length. In related aspects, the pieces are not greater than a digital word in length. In yet still others, a kilobyte in length. And, so forth.

Yet still further aspects of the invention provide a method for transfer of digital media objects, e.g., as described above, further including rendering substantially inaccessible and/or unusable, for example, by nullifying, each respective piece of the digital file on the first digital data device in connection with transferring it to the second digital data device. In some aspects, such nullification can be effected prior to initiating the transfer; in others, substantially concurrently with effecting the transfer; and, in still others, subsequent to effecting the transfer. In that latter regard, in some aspects, the transfer step includes rendering substantially inaccessible, unusable and/or nullifying (hereinafter, “nullifying, “nullification,” or the like, unless otherwise evident from context) each respective piece of the digital file on the first digital data device after verification of receipt and/or storage of that piece on the second digital data device.

Further aspects of the invention provide a method for transfer of digital media objects, e.g., as described above, in which sizes of the respective pieces of the digital file and/or a timing of transfer and/or nullification of those pieces to the second digital data device insure that no respective piece of the digital file is concurrently stored on the first and second digital data devices and/or, more generally, so that any same portion of the digital file that is concurrently stored on the first and second digital data devices comprises not more than an insubstantial amount of the digital data file—or, in related aspects of the invention, to insure that not more than an insubstantial amount of a creative work embodied in the digital data file is embodied in portions of the digital file that are concurrently stored on those devices.

Still other aspects of the invention provide a method for transfer of digital media objects, e.g., as described above, in which the transferring step includes transferring to the second digital data device patterns representing each a respective piece of the digital file. In one related aspect, each such pattern can include the respective piece of the digital file, along with an error-correcting code. In a further related aspect, the step of storing the respective piece of the digital data file to the second digital data device can include utilizing the error-correcting code to identify and/or correct errors in the piece represented by the respective pattern.

In another related aspect, the invention provides a method for transfer of digital media objects, e.g., as described above, in which each pattern can be a mask-encoded representation of the respective piece, e.g., where that mask is constant or, alternatively, varies for each respective piece or, further alternatively, comprises one or more encryption code, or otherwise. The method can further include exchanging the mask (or masks) between the first and second digital data devices, and the step of storing the respective piece of the digital data file to the second digital data device can include utilizing the mask to discern the respective pieces from the pattern. Further related aspects of the invention provide such methods in which the transferring step includes utilizing a randomly generated mask or one or more encryption codes to generate the pattern for each of one (or more) respective pieces.

In other aspects, the invention provides a method for transfer of digital media objects, e.g., as described above, in which the transferring step includes the step of transferring to the second digital data device the respective pieces of the digital file in an ordered succession, e.g., beginning with the end of the file and progressing to the beginning of the file. In the latter such aspect, the nullifying step can include at least one of modifying an end-of-file pointer in connection with the transfer of each respective piece and/or nullifying (e.g., zeroing) values contained in the respective piece of the digital file on the first digital data device.

Further aspects of the invention provide a method for transfer of digital media objects, e.g., as described above, in which transferring step includes transferring the respective pieces of the digital file to the second digital data device via one or more other “intermediary” digital devices, e.g., servers. In some related aspects of the invention, those intermediaries receive from the first digital data device one or more respective pieces and, then, transmit that/those respective pieces to the second digital data device. In other related aspects, those intermediaries are configured as a shift register bus to transport the respective pieces, e.g., serially, from the first device to the second device.

The methods above are, in some aspects, effected such that no respective piece of the digital file is concurrently stored on any two digital data devices and/or, more generally, so that any same portion of the digital file that is concurrently stored on any two digital data devices comprises not more than an insubstantial amount of the digital data file—or, in other aspects, so that not more than an insubstantial amount of a creative work embodied in the digital data file is embodied in portions of the digital file that are concurrently stored on any two devices.

Further aspects of the invention provide a method for transfer of digital media objects, e.g., as described above, in which sizes of the respective pieces of the digital file and/or a timing of transfer of those pieces to the second digital data device insure that no respective piece of the digital file is concurrently stored on any two digital devices and/or, more generally, so that any same portion of the digital file that is concurrently stored on any two digital data devices comprises not more than an insubstantial amount of the digital data file—or, in related aspects of the invention, to insure that not more than an insubstantial amount of a creative work embodied in the digital data file is embodied in portions of the digital file that are concurrently stored on any two devices.

Yet still further aspects of the invention provide methods for the transfer of digital media objects, e.g., as described above, as facilitate changes of ownership thereof. Related aspects of the invention provide such methods as facilitate the (re)sale, lending, streaming or other transfer of digital music, digital books or other digital media objects.

Still other aspects of the invention provide digital data devices, digital data processors and digital data processing systems (including one or more digital data processors, networked or otherwise) operating in accord with the methods above.

### BRIEF DESCRIPTION OF THE DRAWINGS

A more complete understanding of the invention may be attained by reference to the drawings, in which:

FIG. 1 depicts a digital data processing system 10 of the type in which the invention may be practiced;

FIGS. 2A-2D depict a further digital data processing system and method according to the invention;

FIG. 3A-3F depict a still further digital data processing system and method according to the invention;

FIG. 4 depicts the blocks that make up a file on disk;

FIG. 5 depicts a typical file system;

FIG. 6 depicts a file copy in a typical file system;

FIG. 7 depicts a typical file transfer mechanism from a client side perspective;

FIGS. 8-9 depict a file transfer in a system according to the invention;

FIG. 10 depicts examples of the exclusive OR (XOR) of a source with a mask in a system according to the invention; and

FIG. 11 depicts graphically depicts a file transfer in a system according to the invention.

### DETAILED DESCRIPTION OF THE ILLUSTRATED EMBODIMENT

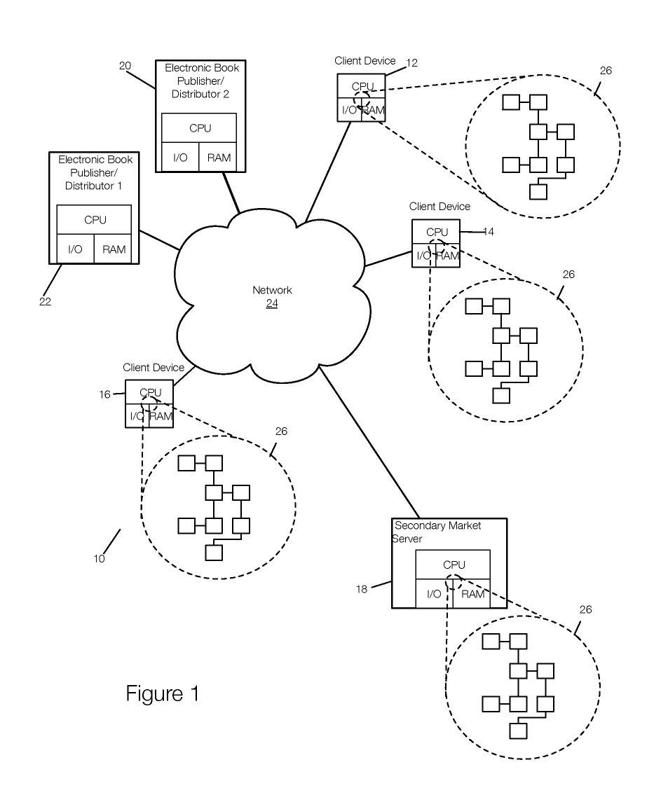

FIG. 1 depicts a digital data processing system 10 of the type in which the invention may be practiced. The illustrated system includes one or more client digital data processors 12-16 and one or more server digital data processors 18-22, each comprising mainframe computers, minicomputer, workstations, desktop computers, portable computers, tablet computers, smart phones, personal digital assistants or other computer apparatus of the type commercially available in the marketplace, as adapted in accord with the teachings hereof. As such, each of the devices 12-22 is shown as including CPU, I/O and memory (RAM) subsections, and nonvolatile storage (not shown), by way of non-limiting example. In the illustrated embodiment, clients devices 12-16 are computers, smartphones, and the like of the type used by consumers.

The digital data processors 12-22 may be connected permanently, intermittently or otherwise by a network, here, depicted by “cloud” 16, which may comprise an Internet, metropolitan area network, wide area network, local area network, satellite network, cellular network, and/or a combination of one or more of the foregoing, as adapted in accord with the teachings hereof. And, though shown as a monolithic entity in the drawing, in practice, network 24 may comprise multiple independent networks or combinations thereof.

Thus, by way of non-limiting example, client digital data processors 12-16 operate in the conventional manner known in the art, as adapted in accord with the teachings hereof, e.g., with respect to the transfer of digital media objects, e.g., computer or other digital files, that embody creative works, such as by way of non-limiting example, digital songs, videos, movies, electronic books, stories, articles, documents, still images, video games, other software, and/or combinations of the foregoing—just to name a few.

And, by way of further non-limiting example, the client digital data processors 12-16 hereof may operate in the manner of “computer 22” (by way of example) described in co-pending, commonly-assigned U.S. patent application Ser. No. 13/406,237 and corresponding PCT Patent Application Serial No. PCT/US2012/026,776 (now, Publication No. WO 2012/116365), both filed Feb. 27, 2012, and both entitled “METHODS AND APPARATUS FOR SHARING, TRANSFERRING AND REMOVING PREVIOUSLY OWNED DIGITAL MEDIA” and, more particularly, by way of non-limiting example, in FIG. 5 of those applications and in the accompanying text thereof; and, to that end, the client digital data processors 12-16 hereof may execute software and/or include functionality of the type ascribed to the “Manager App. 23” shown in those FIG. 5 and described and referred to the accompanying text, e.g., under the names “management software,” “Manager Application,” “management system,” “management software,” and the like, that facilitate access control to digital media objects stored in those respective digital data processors 12-16 hereof as well as to such objects stored in digital data processor 18 hereof. The teachings of the above-cited applications and cited portions thereof of are incorporated herein by reference.

Server 18 is a computing device of the type employed by a service operator of the type that facilitates the (re)sale, lending, streaming or other transfer of digital music, digital books or other digital media objects. By way of non-limiting example, it may operate in the manner of the ReDigi™ commercial marketplace currently operating at www.redigi.com. Alternatively, or in addition, it may operate in the manner of “remote server 20” described in Figures of the above-cited applications and in the accompanying text thereof; and, likewise, to that end, the server digital data processor 18 hereof may execute software and/or include functionality of the type ascribed to the “mgr app 25” shown in those FIG. 5 and described and referred to the accompanying text, e.g., under the names “management software,” “Manager Application,” “management system,” “management software,” and the like, that facilitate effect access control to digital media objects stored on server 18 hereof as well as to such objects stored in digital data processors 12-16. Again, the teachings of the above-cited applications and cited portions thereof of are incorporated herein by reference.

Regardless of whether operating in accord with “computer 22” and “remote server 20” of the above-cited applications, one or more of those devices 12-18 executes software that operates independently on each such device 12-18 and/or, more typically, with like software on one or more of the other devices 12-18 to facilitates transfer of digital media objects (e.g., digital files) via migration in accord with the teachings hereof. In the text that follows, that software is referred to as “migration manager software” 26, though, it may (in some embodiments) also effect access control, e.g., in the manner described in the above-cited incorporated-by-reference application.

In the text that follows and elsewhere herein, the operation of that migration manager software is ascribed to the devices 12-18 on which it operates. As will be evident to those skilled in the art, whether ascribed to the migration manager software or the devices themselves, the file transfer by migration operations described here may involve not just the management software but, also, conventional software (such as operating system software, for example) and hardware (such as network interface cards), and the like, provided with those devices 12-18.

Servers 20-22 are computing devices of the type employed by electronic music, electronic book and other digital media object sellers and distributors of the type known in the marketplace, such as Amazon's same-named retail web site, Apple's iTunes website, to name just a few. In the illustrated embodiment, those servers download (e.g., upon purchase or otherwise) to devices 12-18 music files, digital books, video files and other digital media objects. Such downloads can be accomplished in the conventional manner known in the art—though, it can also be accomplished utilizing the file transfer by migrations operations described herein.

Regardless, the embodiments described here illustrate how such digital media objects can be transferred among and between devices 12-18 via migration. Of course, it will also be appreciated that those operations may be performed on digital media objects other than those downloaded from servers 20-22 and, thus, for example, they can be performed on digital media objects created in the first instance by authoring tools on the devices 12-18, by scanning, ripping or other conversion of creative works from hardcopy to digital media objects, or otherwise.

By way of overview, the migration manager software 26 executing on one of the devices, e.g., client digital data processor 12, transfers a digital media object (or digital media file) stored on a disk drive or other storage device of the device 12 to one of the other devices, e.g., client digital data processor 14, for storage to a disk drive or other storage device of that device 14. The migration manager software 26 of device 12 (operating independently and/or in cooperation with migration manager software 26 of device 14) effects the transfer through successive steps of:

(i) transferring to device 14 a respective piece of the digital media object, and

(ii) storing that respective piece of the digital media object on device 14.

The foregoing steps are, preferably, effected so that no respective piece of the digital file is concurrently stored on devices 12, 14 and/or, more generally, so that any same portion of the digital file that is concurrently stored on those devices comprises not more than an insubstantial amount of the digital data file—or, put another way, so that no respective piece of the digital file is concurrently stored on devices 12, 14 and/or, more generally, so that not more than an insubstantial amount of a creative work embodied in the digital data file is embodied in portions of the digital file that are concurrently stored on those devices.

In some embodiments, this is achieved through sizing of the respective pieces of the digital file (e.g., transferring byte-sized pieces vs. digital word-sized pieces vs kilobyte-sized pieces, and so forth). Thus, for example, the migration manager software can transfer pieces of the digital file not greater than a byte in length, not greater than a digital word in length, not greater than a kilobyte in length, and so forth, depending on the extent of desire to insure that any same portion of the digital file that is concurrently stored on those devices comprises not more than an insubstantial amount of the digital data file—or, put another way, so that no respective piece of the digital file is concurrently stored on devices 12, 14 and/or, more generally, so that not more than an insubstantial amount of a creative work embodied in the digital data file is embodied in portions of the digital file that are concurrently stored on those devices.

Moreover, in some embodiments, the migration manager software 26 of device 12 renders substantially inaccessible, unusable and/or nullifies (hereinafter, “nullifies,” “nullifying, “nullification,” or the like, unless otherwise evident from context) each respective piece of data in connection with its transfer to device 15. This can be effected prior to initiating the transfer, substantially concurrently with effecting the transfer, subsequent to effecting the transfer, or otherwise. In that latter regard, the migration manager software 26 of device 12 can nullify a respective piece of the digital file on device 12, e.g., after verification of receipt and/or storage of that piece on device 14 by migration manager software 26 on that device.

In some embodiments, the migration manager software 26 of device 12 (acting alone and/or in connection with that of device 14) sizes the pieces and/or times their transfers (and nullification) so that that no respective piece of the digital file is concurrently stored on multiple devices and, more generally, so that any same portion of the digital file that is concurrently stored on multiple devices comprises not more than an insubstantial amount of the digital data file (or, alternatively put, so that not more than an insubstantial amount of a creative work embodied in the digital data file is embodied in portions of the digital file that are concurrently stored on multiple devices).

An insubstantial amount, as the term is used here, typically means a small amount. In some embodiments, this can be as little as a digital byte and in other embodiments a digital word (e.g., between two and eight bytes). Yet, in still other embodiments, it can be as little as a kilobyte—or potentially larger. Still in other embodiments, an insubstantial amount means an amount defined in accord with the copyright laws and, particularly, that area of the copyright laws concerned with copyright infringement. This may vary in accord with type of creative work represented by the digital file being transferred.

In some embodiments, the migration manager 26 of device 12 transfers pieces of the digital file stored on that device in an ordered succession, e.g., beginning at the end of the file and progressing to the beginning of the file. In the latter regard, the migration manager can nullify each respective piece by, for example, zeroing out all data at and end-of-file pointer in the digital file stored on device 12. That migration manager 26 can, instead or in addition, modify the that end-of-file pointer so as to exclude the respective piece from the file. In some embodiments, this can be accomplished using “set file length,” “truncate,” “setendoffile” operations, or the like. This can be advantageous because these are, typically, user-level file system commands or API's, as opposed, for example, to kernel operations or operations that require modification of the native file system or operating system.

An appreciation of the operation of the migration manager(s) 26 of the illustrated embodiment in the foregoing regards—and, more generally of digital data processors and digital data processing systems employing such a migration manager 26, like functionality and/or operating in a like manner—may be attained by reference to the Appendix hereof and, particularly, for example, to the discussion of block by block, reverse file migration in Section 3 (and its subsections) thereof.

In other embodiments of the invention, the migration manager 26 of device 12, for example, utilizes methodologies as discussed above and in Section 3 of the Appendix hereof, yet effects transfer of a digital media file stored device 12 to device 14 for storage there by transferring patterns representing each respective piece of the digital file. Such patterns can include the respective piece of the digital file, e.g., along with an error-correcting code. The migration manger of device 14 can utilize that code, for example, to identify and/or correct errors in the piece represented by the respective pattern, e.g., before storing it to disk or other storage medium of device 14.

In other embodiments of the invention, the migration manager 26 of device 12 employs as such patterns mask-encoded representations of the respective pieces of the digital file stored on that device. The mask, which can be constant for all pieces or, alternatively, can vary for respective pieces or, further alternatively, can comprise one or more encryption codes, or otherwise, can be generated and sent by the migration manager of device 14 to the migration manager of device 12 (if not already “known” by it, e.g., via pre-coding, defaults, or otherwise) for its use in generation of the patterns. In these embodiments, the migration manager of device 12 preferably destroys any masks sent to it by device 14 (after the patterns are generated); conversely, the migration manager of device 14 utilizes the mask(s) to discern the respective pieces from the respective patterns for storage on device 14 (and it, too, can destroy the masks after they are so used).

An appreciation of the operation of the migration manager(s) 26 of the illustrated embodiment in the foregoing regards—and, more generally of digital data processors and digital data processing systems employing such a migration manager 26, like functionality and/or operating in a like manner—may be attained by reference to the Appendix hereof and, particularly, for example, to the discussion of “teleportation” in Section 4 (and its subsections) thereof.

According to related embodiments of the invention, the migration manager of device 12 transfers the digital file stored on that device to device 14 via one or more other digital data devices, e.g., server 18. This can be accomplished, for example, by employing the techniques discussed above (whether in regard to the transfer of pieces and/or patterns based thereon), first, to transfer the digital file from device 12 for storage on device 18, and second, to transfer the digital file from device 18 for storage on device 14.

It can also be accomplished by employing device 18 as an intermediary transfer node that routes but does not store the respective pieces of the digital file as they are transferred from device 12 to device 14—or, to the extent that they are stored on device 18, sizing the pieces and/or timing the transfers (and/or nullifications) such that no respective piece of the digital file is concurrently stored on multiple devices and, more generally, so that any same portion of the digital file that is concurrently stored on multiple devices comprises not more than an insubstantial amount of the digital data file (or, alternatively put, so that not more than an insubstantial amount of a creative work embodied in the digital data file is embodied in portions of the digital file that are concurrently stored on multiple devices).

Extending this further, some embodiments utilize multiple such intermediary transfer nodes—whether servers (such as device 18), other client devices or otherwise. An appreciation of the operation of the migration manager(s) 26 of the illustrated embodiment in this regard—and, more generally of digital data processors and digital data processing systems employing such a migration manager 26, like functionality and/or operating in a like manner—may be attained by reference to the Appendix hereof and, particularly, for example, to the discussion of Information Dispersal in Section 5 (and its subsections) thereof.

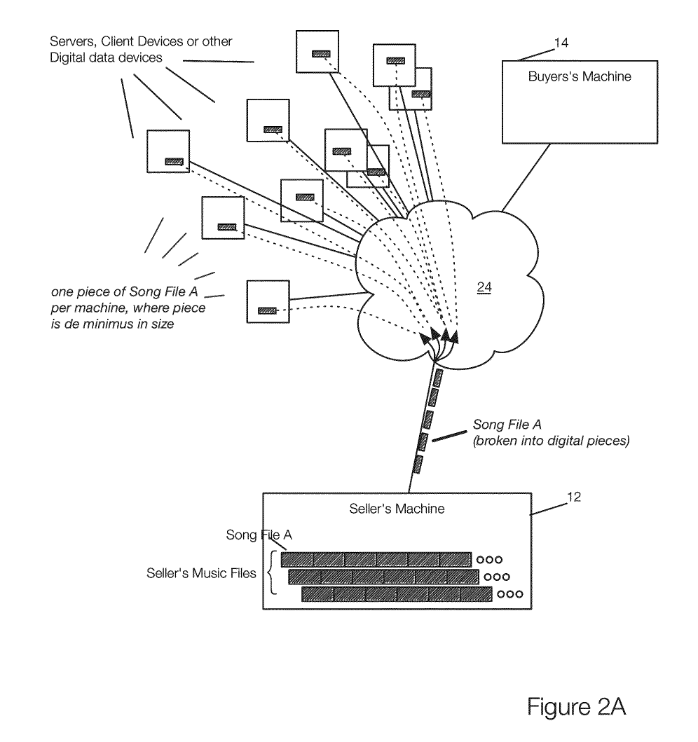

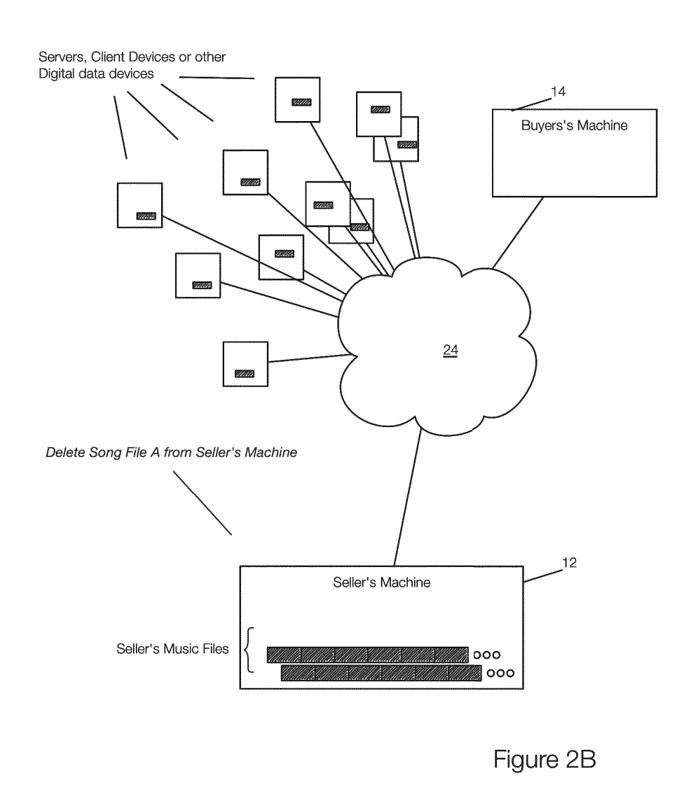

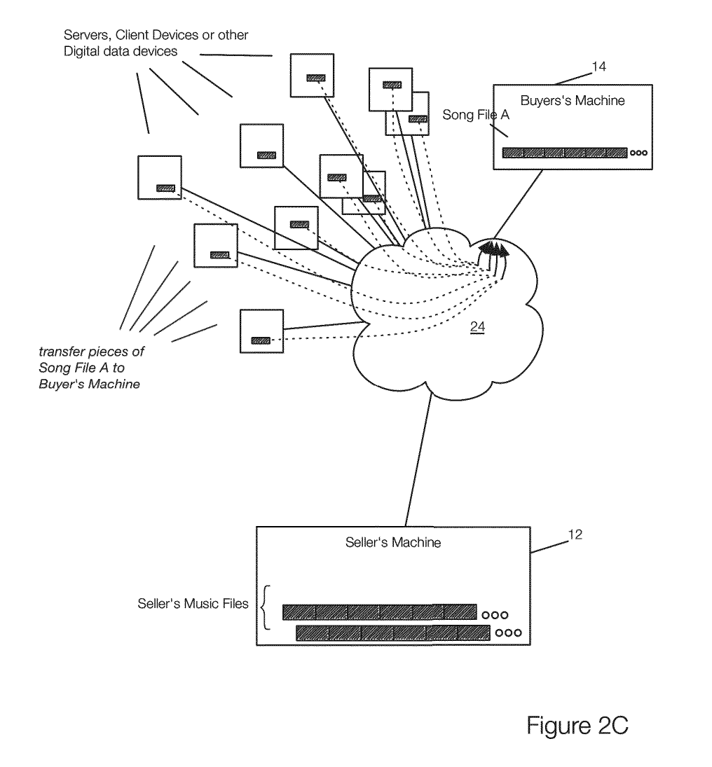

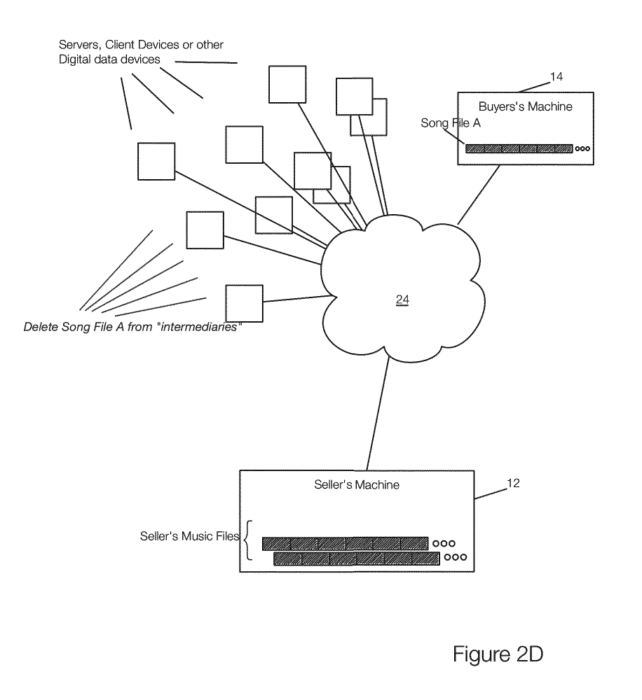

A still further appreciation of the operation of the migration manager(s) 26 of the illustrated embodiment in this regard—and, more generally of digital data processors and digital data processing systems employing such a migration manager 26, like functionality and/or operating in a like manner—may be attained by reference to FIGS. 2A-2D illustrating steps executed by the migration manager(s) 26 in this regard.

Thus, for example, in FIG. 2A there is shown a step of breaking the digital file on device 12 into tens, hundreds, thousands, millions (or more) pieces (e.g., of byte-length, word-length, etc., depending on implementation), and dispersing them (directly and/or as patterns based thereon, as discussed above) to a network of intermediary servers, other client devices and/or other digital data devices. In FIG. 2B, there is shown a step of nullifying the digital file on device 12, e.g., once the intermediaries have confirmed receipt of respective pieces of that file (or patterns based thereon). In FIG. 2C, there is shown transmitting the pieces from the intermediaries to the device 14 for storage thereon. And, in FIG. 2D, there is shown nullifying the pieces on the intermediaries, e.g., once the device 14 has confirmed receipt of the pieces. As above, the pieces are sized and/or times their transfers (and/or nullification) selected so that that no respective piece of the digital file is concurrently stored on multiple devices and, more generally, so that any same portion of the digital file that is concurrently stored on multiple devices comprises not more than an insubstantial amount of the digital data file (or, alternatively put, so that not more than an insubstantial amount of a creative work embodied in the digital data file is embodied in portions of the digital file that are concurrently stored on multiple devices).

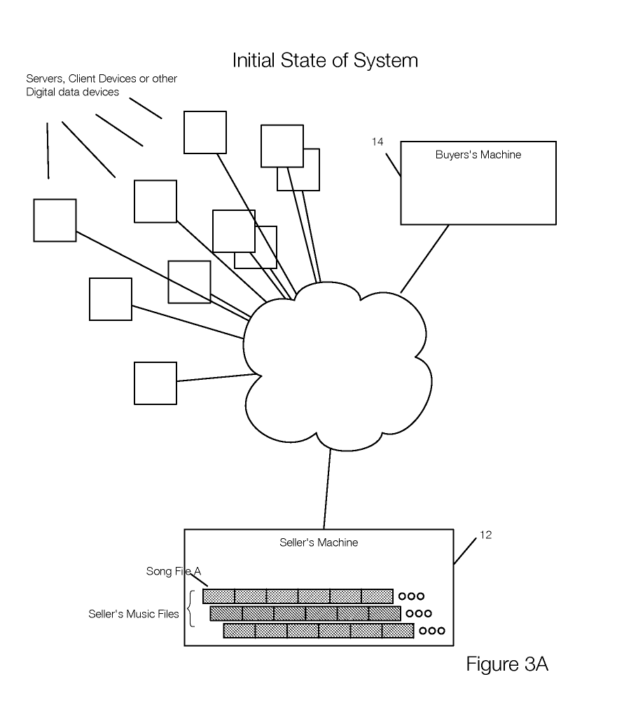

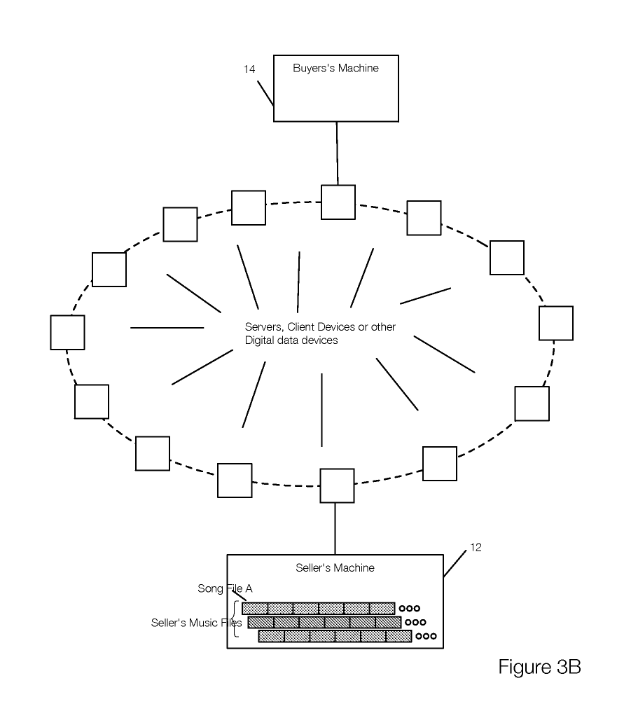

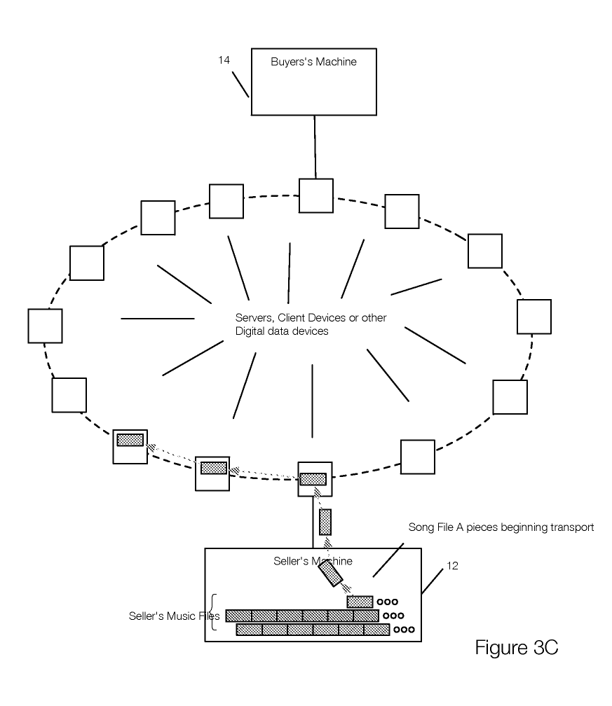

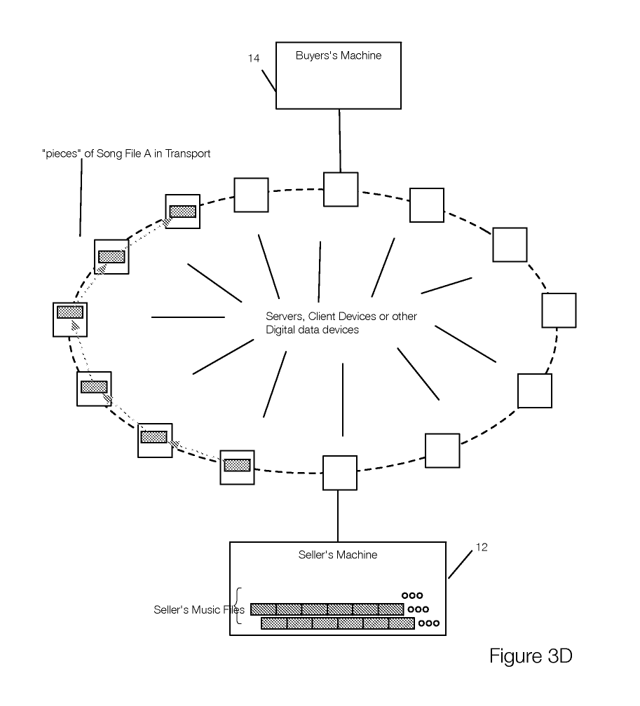

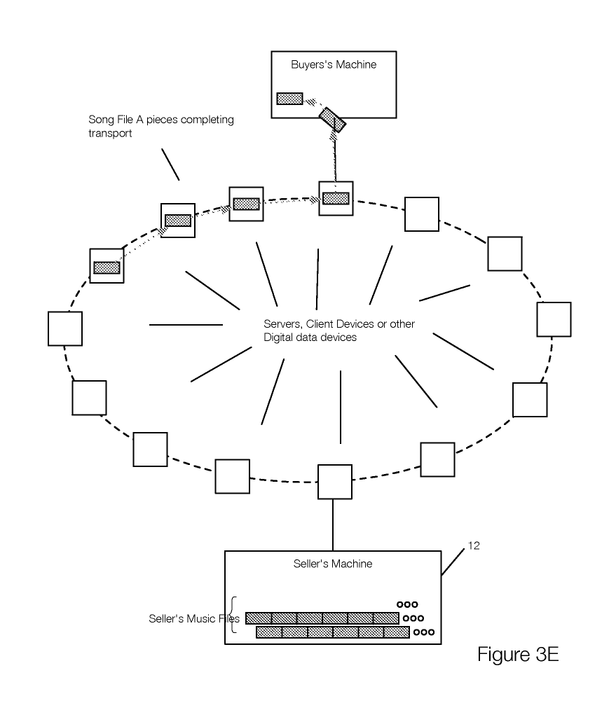

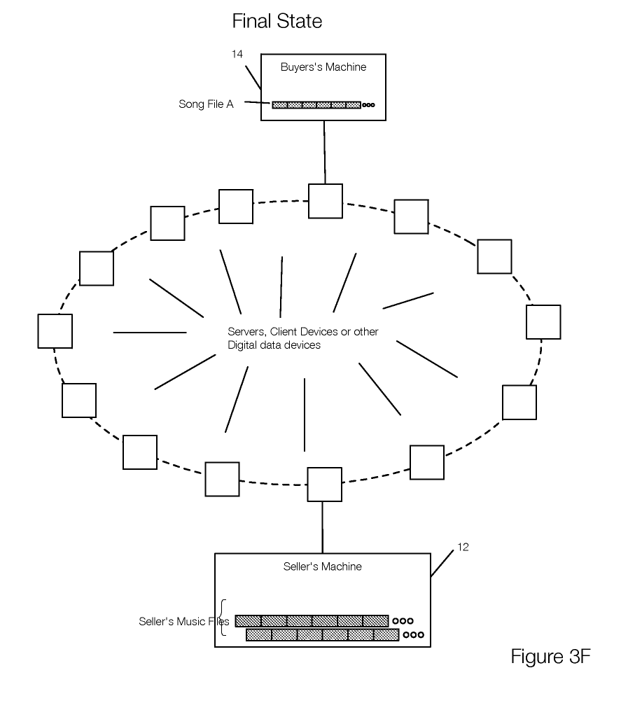

FIGS. 3A-3F depict a related but alternate use of the intermediary servers. Rather than dispersing tens, hundreds, thousand, millions (or more) pieces to them, e.g., at one time, migration managers 26 running on them and/or the devices 12, 14, configure those intermediaries as a virtual shift register. See FIG. 3A (intermediaries as initially configured) and 3B (intermediaries configured as virtual shift register). As shown in FIG. 3C, the migration manager 12 on device 12 transmits pieces (e.g., bytes, words, etc.) of the digital file to that intermediary-based virtual shift register. In FIG. 3D, there is shown serial transit of the pieces along the virtual shift register toward device 14. In FIG. 3E, there is shown off-loading of the pieces from the virtual shift register onto that device 14 for storage there. In FIG. 3F, there is shown the final state of they system, with the digital file now stored on device 14. As above, the pieces are sized and/or times of their transfers (and nullification) selected so that that no respective piece of the digital file is concurrently stored on multiple devices and, more generally, so that any same portion of the digital file that is concurrently stored on multiple devices comprises not more than an insubstantial amount of the digital data file (or, alternatively put, so that not more than an insubstantial amount of a creative work embodied in the digital data file is embodied in portions of the digital file that are concurrently stored on multiple devices).

The network of intermediary digital data devices utilized in the embodiment discussed above (and below) may comprise many devices (e.g., tens, hundreds, thousands, and so forth). However, a smaller number of devices may used instead, and each may serve the roll of a larger number of devices. To this end, the migration manager of each of the (smaller number of) devices may open and dedicate to the migration process multiple ports (e.g., tens, hundreds, etc.), each preferably supported by a different thread or process. Depending on how they are configured each such port/thread combination may be treated as a separate device for purposes of executing methods in accord herewith; hence, multiplying the effect of the smaller number of devices into a virtual network of the many alluded to above.

Regardless of their number, the intermediary transfer nodes can further facilitate the transfer of a digital file between devices 12, 14, e.g., by insuring that the transfers occur even if one of those devices 12, 14 goes offline and/or temporarily fails—or, more generally, if both of those devices are not concurrently online and in communication with one another.

Thus, for example, if device 14 were to go off-line during execution of the operation exemplified in FIG. 2C, i.e., during transmission of pieces of the file from the intermediaries to the device 14 for storage thereon. migration management software 26 on those intermediaries and/or device 14 could effect re-starting of such transmission once the device 14 were to go back online. Likewise, if device 12 were to go offline during the operation exemplified in FIG. 2A, migration management software 26 on intermediaries and/or device 12 could effect re-starting of dispersal of the pieces to those intermediaries once the device 12 were to go back online and, moreover, working with software 26 on device 14, could effect transmission of those pieces to that device at a time when it was available for such.

Although in the examples above, methods of the illustrated embodiments are utilized to transfer of digital media objects (e.g., digital files) via migration between client digital data processors 12, 14, those methods can be used as well in connection with transfers to and from servers (and other devices). Thus, for example, such methods can be used to transfer (“download”) digital media objects from servers 20-22 of digital media sellers and distributors to client digital data processors 12, 14 of customers of those sellers/distributors. By way of further example, such methods can be used in connection with transfers of digital media objects between client devices and servers in systems of the type described in aforementioned U.S. patent application Ser. No. 13/406,237 and corresponding PCT Patent Application Serial No. PCT/US2012/026,776 (now, Publication No. WO 2012/116365) in connection with the (re)sale, lending, streaming or other transfer of digital media objects as described therein.

Advantages of methods of the illustrated embodiments (as well as apparatus operating in accord therewith) for these and other uses is that they facilitate the transfer of digital media objects without copying, e.g., so that no portion of such an object being transferred is concurrently stored on multiple devices and/or, more generally, so that any same portion of the digital file that is concurrently stored on multiple such devices comprises not more than an insubstantial amount of the digital media object—or, put another way, so that not more than an insubstantial amount of a creative work embodied in the digital media object is embodied in portions of that object that are concurrently stored on such devices.

In this regard, it will thus be appreciated that such methods (and apparatus) for file transfer by migration in accord with the teachings hereof may be used for the sale, (re)sale, lending, streaming or other transfer of digital media objects directly between client (or other) devices 12, 14, e.g., regardless of whether used in connection with a “remote server 20” of the type disclosed in the aforementioned patent application and/or with “management software,” “Manager Application,” “management system,” “management software” of the type also disclosed in that application (e.g., as “Manager App. 23” or “mgr app 25” of FIG. 5 thereof)—though use with such a server and management software (and specifically, for example, with the digital media object validation, post-sale compliance, buyer/seller matching, and other mechanisms thereof) may, in some instances, further facilitate the sale, (re)sale, lending, streaming or other transfer of digital media objects.

Described above and shown in the drawings are systems and methods meeting the objects set forth herein, among others. It will be appreciated that the embodiments here are mere examples of the invention, and that others employing changes hereto fall within the scope of the invention. Thus, for example, it will be appreciated that, although many of the examples above involve transfer of a digital file from device 12 to device 14 (possibly through other devices, e.g., 18), in many embodiments, the migration manager software facilitates transfer in all (or many) directions and between many combinations of devices. And, by way of still further example, it will also be appreciated that the mechanisms taught herein can be used with (i) systems in which possession or transfer of a digital media object embodying a particular copy of a creative work can—like the possession or transfer of a physical object (e.g., a book, record album, DVD, etc.) embodying such a particular copy—reflect ownership or transfer thereof, as the case may be, of the digital media object and the particular copy embodied therein, (ii) systems in which ownership or the transfer thereof in a digital media object and/or the particular copy embodied therein or otherwise represented thereby is reflected by a central registry, by links, by pointers or otherwise, as well as with (iii) still other systems now or heretofore known in the art.

### APPENDIX

This appendix describes several ways, according to respective embodiments of the invention, to migrate a file between two storage devices that does not involve copying the file. One way sends the bytes in the file starting at the end of the file and moving towards the head of the file. The last block of the file is stripped off, the file size reduced (using the truncate or “setendoffile” operation, and the bytes in the file are reversed and sent to the server. The file on the users machine continually shrinks in size until it is zero bytes in length. The destination receives and stores the bytes in this reverse order and stores them on disk. When read, from disk, the file is reversed again so that the file is in the right order.

Another migration method splits the file into many tiny chunks and adds more tiny chunks of Reed-Solomon (or other) error correct codes for these tiny chunks. The chunks are then spread out over a large number of servers and a large number of pipes within each server. These geographically scattered pieces, some of which may be dropped or lost during the scattering process, cannot be considered a copy of the original file. They are worthless until they are all brought together at a single machine and re-assembled. The error correcting pieces are used to fill-in the missing pieces.

Yet another method creates a mask file of random bits at the destination. A copy of this file is sent to the source where the original file is modified by exclusive ORing the bits of the file with these random bits of the transmitted file. The original file is still the same file, except that the mask file is need in order to interpret the bits. The mask file is then deleted, leaving the original file indecipherable. The file is no longer capable of being interpreted. It is then sent to the destination where it can be interpreted and it comes to life again.

A corresponding method to the foregoing is to use one or more encryption codes as mask(s).

### 1. Introduction

Computer systems are organized in layers of abstraction where each layer is implemented by different software components. The three main layers that are relevant to the discussion below are the programming layer, the operating system layer and the file system layer. Although the file system may be considered part of the operating system, its interface is not exposed to the programming layer. In other words, to perform an operation on files, the program makes a request to the operating system. The operating system, in turn, makes requests to the file system.

It is difficult and often undesirable to modify the operating system. Even more so, the file system. Modifying either or both of these systems permit many ways to “migrate” a file—a term used here to refer to moving a file without copying it. The methods described here do not require OS or File System modifications, rather, everything can done at the programming level using standard programming instructions for the type known in the art, albeit has adapted in accord with the teachings hereof.

Shown here are three ways this can be accomplished. One way is to remove a piece, send it, and reconstruct at the destination. Another way is to blast the file into an enormous number of small pieces and scatter these pieces among many different locations, and then to reassemble them at the destination. Yet another way is to make the file disappear at the source and to reappear at the destination at some later time. After some background in the following section, these alternatives are specified in the subsequent three sections.

### 2. Background: Current Practice

The file system is a part of the operating system that handles operations that deal with computer files. The files can be stored on some non-volatile digital storage device such as a hard disk drive. This can be attached within the laptop or computer case, external connected by a USB cable, or attached via a local network or global, internet network. The following subsection gives an overview of file systems. The standard, current way to transfer a file from one machine to another uses the File Transmission Protocol (FTP). The second subsection reviews this protocol.

### 2.1 Unix-Like File Systems

The unix-like file systems are the easiest to understand and are the basis for most popular ones. From a file system programming point of view, the disk consists of a collection of blocks. A block might be 1024 bytes of data, and so a terabyte (trillion bytes) disk may have about 10 billion blocks. A block might be 4096 bytes, and so a terabyte disk would have only 2.5 billion blocks. These blocks are allocated on different tracks, sectors, and platters of the disk drive, but that detail is hidden from the low-level programming software layer.

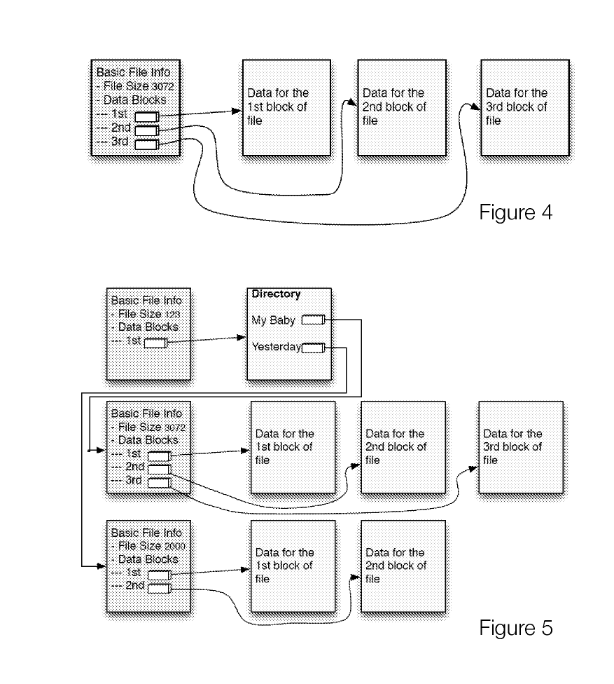

Referring to FIG. 4, there are shown the blocks that make up a file on the disk. The leftmost block is a special one, called an iNode. It contains information about the file, such as its size and pointers to the data blocks that represent that data of in the file. In this diagram, the file consists of 3072 bytes that are contained in 3 data blocks.

FIG. 4 shows the blocks of one small file. There are four blocks. The first block, which is the one on the left in the figure, is referred to as an index block, and in Unix, this is called an iNode. Not all file systems use exactly this organization or terminology, however, the popular ones use something very much like this organization, including Macintosh and Windows.

Although each file is a collection of blocks, there is another organizational layer of the file system. Files have names. Files are also contained in directories or folders. A directory is just a special file. It has a name, referred to as the directory or folder name. It also has a size and some other attributes. The data of the directory file is organized simply as a list of file name, iNode number. There may be other attributes in each entry, such as the time and date the file was created, was last accessed, as well as access permissions and restrictions.

FIG. 5 shows three files, one per row. They have the same format as shown in FIG. 4. The top row is a special file, which is a directory or folder file. There are two files in the folder. This directory file has the names of the files in the folder and pointers to the iNode for each file.

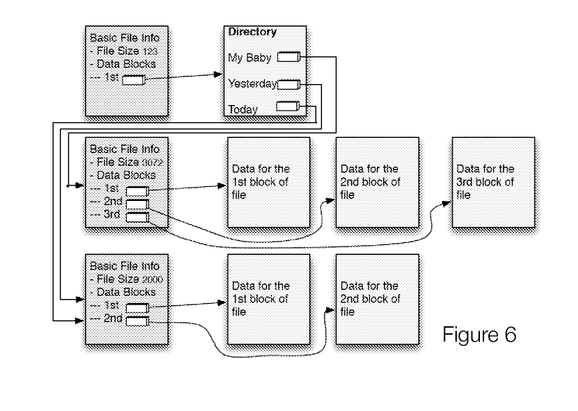

It is worthwhile noting at some file systems allow several file names in directory files to point to the same iNode. FIG. 6 shows an example of this. The directory contains three files, but the second and third files are actually the same thing. These two file names appear to the user as copies, however, they do not take up extra space on disk. In some file systems this is called a shortcut alias, or hard or soft link. In other file systems, such as zfs, this happens even when a file is explicitly copied.

Unused blocks are all contained in a free list. When the file system needs another block, it takes one off of the free list. When a block is no longer needed, say, because file was deleted or truncated, the block is returned to the free list.

### 2.2 the File Transfer Protocol

A file transfer protocol (FTP) has been developed in the early days of the internet as a way to safely and securely transfer digital files from one machine to another that are both connected to the internet. Since the file size, i.e., the number of bytes in the file, is much larger than the amount of digital information that can be transmitted at any one time, the data is said to be streamed from the source to the destination.

A block of data is read from the file, and then sent out over the internet connection. At the receiving end, each block of data is received and stored.

Each transmitted block is sequentially numbered. If the receiving side gets a block with number i and the next block with number i+2, it knows that one block has been lost. It asks the sender to retransmit that block.

When all the blocks have been successfully received, the receiver sends back a fingerprint code for the file. If this matches the fingerprint code of the sender's file, then the sender knows the file has been transmitted correctly, and it deletes the file. If they do not match, then the file may be resent.

### 2.3 Standard File Transfer Between Machines Over a Network

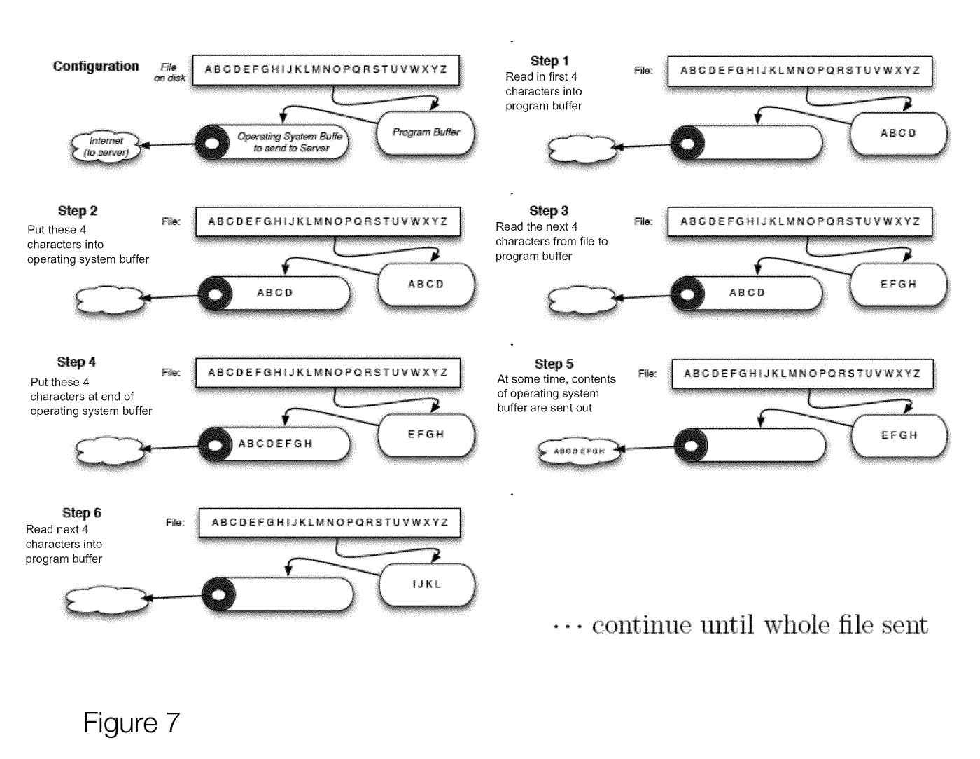

In order to understand the migration of files to the server from a client machine, it is helpful to understand the typical, standard, or normal file transfer mechanism. This subsection explains what happens on the client side during a standard, normal file transfer from a client machine to a server machine. See FIG. 7.

A program tells the operating system that it wants to send data to a particular server following a particular protocol. The operating system gives the program access to a “stream” into which the program writes pieces of data. The operating system periodically transmits this data out of the computer and over a network connection, with the destination IP address specified in the initial part of the data. The program continually writes data into the stream and that data is continually sent to the server. The data is written and delivered in sequential order. This process is ended when the program tells the operating system that all the data has been written to the stream.

FIG. 7 gives an example of how this process works. There is a file, in the figure, the file contains the 26 letters of the alphabet. It is stored on disk. Six stages of the file transfer are shown in the figure. The program reads the first 4 characters from the file into its own local buffer. It then writes these into the operating system stream, which is depicted as a pipe in the figure. The program then reads another 4 characters from the file into buffer. Then it writes these to the operating system stream. Note that they are appended. At some point, the operating system transmits everything in its stream to the network. The figure shows the pipe as being empty. The program reads more characters and writes them to the stream. This continues until the whole file has been transmitted.

Note that the file remains unchanged and that the characters have been transmitted in the order that they resided in the file. At the server or destination, the characters are received and written to a file on the storage device attached to the server. That file grows as more and more characters are written or appended to the end of the file.

### 3 Block by Block, Reverse File Migration

In systems embodying the invention, a file can be migrated from being stored on a disk attached to the client computer to a disk attached to the server in a nonstandard way so that there are never two copies of the data. The data is removed from the client's file and some time later appears in the server's file. Both the Windows and the Macintosh file systems provide an operation to programs that enable them to truncate the file, or change the file size. On Windows, this operation is called “Set End Of File,” while on Macintosh, it is called “truncate′.”

In systems according to the invention utilizing this manner of migration, the process continually shrinks the file. It is as easy to observe the file shrinking on the client's disk as it is to see file on the server grow in size. At any instant during the transfer, the size of the client file plus the size of the server file will be less than the total full size because some of the data is in transit.

### 3.1 Overview of Process

The first step is for the sender, in this example, a client device, to inform the receiver, in this case, a server, of the file attributes, that is, for example, in the case of a music file, the artist name, track title, and album title, of the file that is about to be transmitted. In addition, these attributes are also stored locally. It is possible that there may be a failure during transmission and in such a case, the file will be lost. The system may need this information in order to buy a new instance of the file for the user. Alternatively, each chunk sent may remain until it's successful reception.

The second step in the embodiment described here is to setup a communication stream to the Server. Depending on implementation specifics, the stream has the same interface as a file. The program writes a collection of bytes to the stream. It then flushes those bytes informing the operating system that it can send them out over the internet. In addition, the bytes in the programs buffer are no longer needed.

The file is then transmitted in reverse order. This may seem unusual but it is based on the fact that the Windows file system provides the ability to modify and set the place where the file ends. It allows the program to “truncate” the file. There is an operation called “SetEndOfFile” which can make the file larger or smaller.

Overall, the sequence of interactions between the client and server in some embodiments of the invention employing this methodology is as follows
1. The file size is first sent to the server.
2. A flag indicating the file is reversed is sent to the server
3. The server accepts the stream of bytes and they are then stored into the storage device.
4. The server records the file size, its reversal flag, its location, and its owner
5. When the server needs to provide the contents of the file, that is, read the file, it either reads it in the forward direction, as is usually done, or reads it in reverse order if it is flagged as a reversed file.

### 3.2 Details of the Sender's Actions in the Embodiment Described Here

The truncate function requires removal of blocks of data from the end of the file. This is because, unfortunately, there is no “Set Beginning Of File” operation in some systems of the type in which the embodiment is employed. The following is a summary of these steps:
1. Read the last block (4096) bytes from the end of the file into a buffer.
2. Optionally zero out the bytes in this last block of the file
3. Reverse the bytes in this buffer.
4. Put these bytes into the data stream to the server
5. Optionally, wait until the destination, confirms the receipt of the data.
6. Truncate the file by 4096 bytes or, on Windows, write an end-of-file to the start of this last block of data.

Step two optionally zero's the block that was just read. This is needed to ensure that the data does not continue to reside on the disk to be used, say if the file is extended. Many file systems, however, will not let any process see the data chopped off from the file, even if the file is re-extended.

The second optional step is to delay truncating the file (in step 5) until a confirmation is returned by the server. This ensures that any crash or disruption of service, would not result in the corruption of the file. The source and the destination each have a part that, together form the whole file. On the other hand, this significantly slows down the transfer process. Moreover, it has less appeal to the intuition of a lay-person: when there is a crash or failure after transmission begins but before it ends, the object being transferred is lost.

Note that reversing a file twice brings it back to its original position. The server receives the file in reverse order. When it wishes to read the file, it does so in reverse order. There is metadata associated with the file storage that indicates, for each file, its order. This is checked before the server reads any file.

Also note that blocks of the file are being removed as their data is being streamed to the server. If there is a crash during this process, the file contents will be lost.

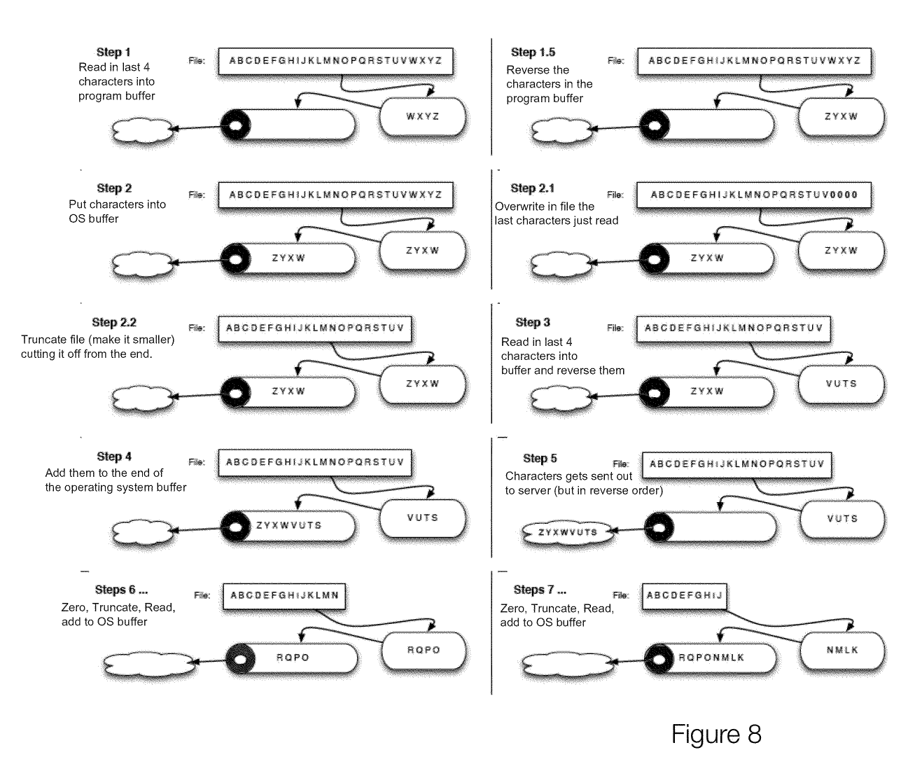

FIG. 8 demonstrates the steps that happen on the client's machine in systems executing in accord with this embodiment. These figures can be compared to the ones in the normal transfer, FIG. 7. Again, there is a file with 26 letters of the alphabet, a buffer in the migration manager software 26 (of FIG. 1, for example) also referred to here as “Migration Manager” program and the stream in the operating system.

Rather than reading the characters from the front of the file, they are read from the end of the file, as seen in the first panel of the figure. They are then reversed in the buffer and written to the operating stream. The characters just read from the file are overwritten with zero's. This is done to ensure that nothing of the original data will remain on the sender's disk. In Macintosh and Windows computers, it is fairly straightforward to recover a file that has been deleted. This is not true with the migration process. The file is then truncated so that these zero's are no longer part of the file. The figure shows how the file shrinks from the end. This process continues until all the characters have been transmitted to the server and the file has zero size. The header block is then removed as well.

FIG. 8 showed what happens to the file from a data point of view. Recall, that files are organized as blocks on the storage device. As the file is truncated, the blocks at the end become disconnected from the file. They are recycled and used to store data of new files as needed.

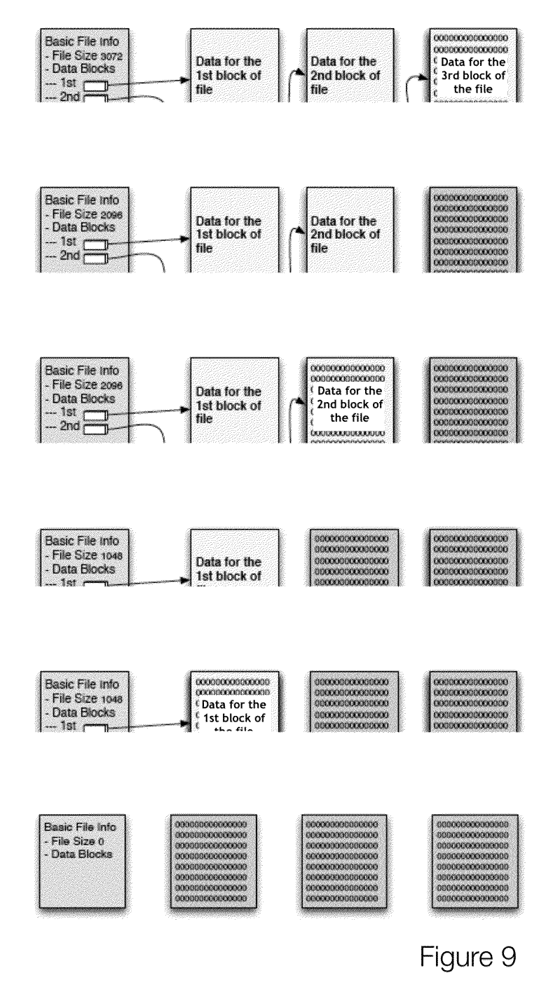

FIG. 9 shows the process from the file system point of view. Here a file consists of three data blocks. The iNode or header block is shown as containing the total file size as well as pointers to the three data blocks. One can then see that the last block of the file is overwritten with zero's. Then, when the file size is truncated to only two blocks, the third block is released and removed from the file. The process continues until there file contains no blocks and its size is zero and the program tells the file system that it can be removed from the directory. In addition, the file attributes are deleted.

### 3.3 Windows Client Code

To make the preceding discussion concrete, this subsection presents code used in the inner loop of the Migration Manger.

Below is a segment of code, in C# that is part of Migration Manger that migrates a file to the server. The lines that begin with back slashes and are in boldface are comments that describe the actions of the following lines of C-sharp program code.

while (numPackets0Based >= 0) {
FileStream fStream = new FileStream(newFile, FileMode.Open,
FileAccess.ReadWrite);
buffer = new byte[4096];
// Seek to the end segment of file to read.
fStream.Seek(numPackets0Based * 4096, SeekOrigin.Begin);
// Read segment.
bytesRead = fStream.Read(buffer, 0, 4096);
byte[ ] nulls = new byte[bytesRead];
// Seek back to beginning of segment to overwrite.
fStream.Seek(numPackets0Based * 4096, SeekOrigin.Begin);
// Overwrite read segment with nulls.
fStream.Write(nulls, 0, bytesRead);
// Remove segment from file. By setting the fileLength smaller,
// we truncate the file, removing all references to the read segment
// and releasing it as unallocated hard drive space with null information.
// Furthermore, since all data has been overwritten with nulls, attempting
// to re-extend the fileLength will fail to reclaim any file data.
//
// This is actually no longer an issue anyway with Windows NT as all file
// extensions now have all newly allocated bytes set to 0, but I thought
// I'd make this explicitly clear as well.
fileLength −= bytesRead;
fStream.SetLength(fileLength);
// Forces all changes to take affect in the file system.
fStream.Flush( );
fStream.Close( );
// Since we are reading from the back, invert data to allow for continuous
// stream of information.
Array.Reverse(buffer);
// Write information to response stream.
rs.Write(buffer, 0, bytesRead);
buffer = new byte[4096];
// Force information into stream in case network device attempts to cache.
rs.Flush( );
// Prepare to move to next segment.
numPackets0Based--;
// Self-assert that I'm a self-asserted genius. Done.
// Recursive definitions ftw.
}

The first line indicates that the rest of the code is to be executed for each packet of the file. The second line opens the music file. The comments then describe all the actions. It should be clear to those of ordinary skill in the art that the code is performing the operations outlined above.

### 4 Teleportation

Although the embodiment described in the previous section transfers a music file from one storage device to another in such a way that the file is replicated at both locations, some embodiments transfer a file in such a way that some can call it akin to teleportation.

The idea is to never directly transfer the actual bits of the file. It is difficult to explain without going into the exact details. This requires one to understand that bits are never fixed in a tangible material object, but rather the thing that is fixed must be interpreted to represent some value.

### 4.1 Exclusive or Operation (Xor)

The exclusive or operation is a logical operation. The usual understanding of the OR operation is as follows. If A is true or B is true, then we say A or B is true. The exclusive or operation requires either A or B to be true but not both.

If we map a ‘0’ to false and a ‘1’ to true, then we get,

| | | | |
|---|---|---|---|
| FALSE | xor | FALSE | FALSE |
| FALSE | xor | TRUE | TRUE |
| TRUE | xor | FALSE | TRUE |
| TRUE | xor | TRUE | FALSE |

In binary notation, this is:

| | | | |
|---|---|---|---|
| 0 | ⊕ | 0 | 0 |
| 0 | ⊕ | 1 | 1 |
| 1 | ⊕ | 0 | 1 |
| 1 | ⊕ | 1 | 0 |

It is a lovely operation. (X xor 1) xor 1=x, similarly (X xor 0) xor 0)=x If you xor a value then what you get, if it is xor with that same value you get back the original.

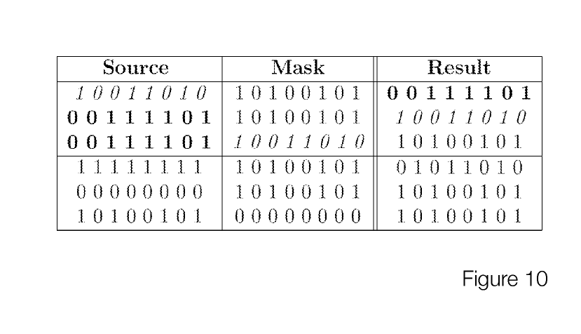

Referring to FIG. 10 there are shown some examples of the exclusive or of source with the mask. Note that the second row uses the result in the first row (bold faced) and exclusive or it with the same mask to yield the initial source. The third row takes the exclusive or of the first row result (bold faced) and the first row source which yields the first row's mask. The last three rows just show some simple other examples.

4.2 Transferring without Copying

In order to understand embodiments of the invention that migrate files by this so-called “teleportation” mechanism, assume there are two storage devices at two different locations. Let us agree to call the first location Home and the second be called the Locker. Home contains, say, a music file, which we will give the name MF and its size as S. The Locker contains a file which we give the name RB and its size is also S, the same as file MF. The file RB consists of randomly generated bits. The file RB therefore has the minimal information content. It's information content is noise. The file RB is transmitted from Locker to Home, and so there are two copies of RB, one at each location.

Using the bits from RB, the file MF is transformed in the following way: the i-th bit of MF is replaced with the result of applying the exclusive or operation of the i-th bit of MF and RB. In other words, if the i-th bit of RB is a zero, then the i-th bit of MF is left unchanged. If it is a one, then the i-th bit is flipped, i.e. if it is 1 it is changed to a 0 and if it is a 0 it is changed to a 1. Since the bits of RF are random, the bits of MF will now also appear random. In other words, for each bit in the MF, there is no way to know it's value without seeing the value in RB. It is very much like the write twice CD, where one bit dictates the interpretation of the other two bits. Since the two files, MF and RB are both on the home machine, together, the fully define the music file.

The music file has not changed in its content. When a file is stored in RAM, the bits are encoded in all sorts of way depending on the exact technology, for example, dynamic RAM stores, reads, and interprets bits much differently than static RAM. Every few years, there are efforts to popularize three-value or four-value logic, in which each storage bit can be in three or four states rather than the typical two. Note that MF is not the same as the usual encrypted file. Without RB, it cannot be decrypted. An encrypted file can be decrypted without the key, given enough time.

Now, suppose we delete the file RB from Home. Locker contains RB and Home contains MF. MF alone is meaningless as is RB. The music file can be considered to be dispersed. No amount of computational effort can extract meaning from MF, since each bit is independent. The file MF has the same information content as RB. Each on its own is nothing. When a music CD is handed from one person to another, and they are both gripping it tightly, it too has no meaning. It cannot be played until both people let go of the disc.

The third step is to send the file MF to the Locker. This is done by removing blocks of data from the file as they are sent to the Locker. When, the whole MF file is at the Locker alongside the file RB, we can say that the music file is now in the locker.

Altogether, migration by teleportation of the foregoing example includes the following steps. Those skilled in the art will appreciate that other embodiments may incorporate variations on that methodology, e.g., employing a lesser or greater number of steps, combining steps, and so forth. Moreover, it will be appreciated that the word “Home” is used, here, to refer to the sender, while the word “Locker” is used to refer to the receiver:
1. Home contains the source file.
2. Home sends Locker the size of the file, S, in bytes.
3. Locker generates a random bit string of S bytes. Call that the mask file.
4. Locker sends the mask file to Home.
5. Home exclusive or's the source file with the mask file, block by block, replacing each block of the source file. Call the resulting file, the phantom file.
6. Home destroys the mask file
7. The original source file is no longer at Home or Locker. It is nowhere. The phantom file has relevant information independent from the mask file.
8. Home sends phantom file to the Locker.
9. Home destroys phantom file.
10. Locker replaces the blocks of the received phantom file with the exclusive or of the corresponding blocks of the mask file.
11. Locker now has the source file. It destroys the mask file.

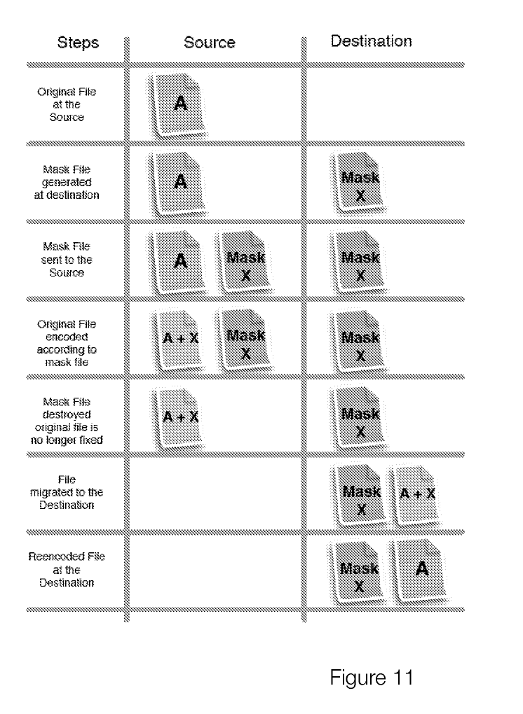

FIG. 11 graphically depicts an effect of execution of these steps.

5. Information Dispersal—Blast the File to Smithereens then Reassemble

Another migration method according to embodiments of the invention splits the file into many tiny chunks and adds more tiny chunks of Reed-Solomon error correct codes for these tiny chunks. The chunks are then spread out over a large number of servers and a large number of pipes within each server. These geographically scattered pieces, some of which may be dropped or lost during the scattering process, cannot be considered a copy of the original file. They are worthless until they are all brought together at a single machine and re-assembled. The error correcting pieces are used to fill-in the missing pieces.

The steps of one methodology in accord with the foregoing are as follows:
1. Select S servers, and setup C channels to each server (total of SC channels.
2. Read in a block from file into a buffer.
3. Truncate the file removing the block
4. Split the 4096 bytes into 512 pieces, each of 8 bytes.
5. Computer 128 error correcting code pieces.
6. Number each piece with its block number and piece number with the block. (code words numbered sequentially after the last piece).
7. Randomly write piece i (of the 512+128 pieces) to a random channel (of the SC channels.
8. Write SC−L pieces according to previous step. L is the number of pieces initially lost. (Others may be lost during transmission as well).
9. Clear buffer and release all pieces from core memory
10 Repeat above steps until who file has been sent

The file is now distributed over the servers and no longer resides on the source computer. Moreover, it does not reside on any one server. The pieces are scattered, and each piece is not useable. Each server waits a random time period, and then sends all of its pieces to the destination. The destination gets pieces and reassembles them. Each block must have at least SC pieces to correctly reassemble them. In addition to pieces of the file, there can also be sent some file-wide correction blocks, which would help the file from getting destroyed. (This can be employed for the file reversal block by block migration, as well.)

1. A method for transfer of digital media objects, comprising migrating to a second digital data device a digital data file that is stored on a first digital data device by repeating a plurality of times the steps of:
(i) transferring to a second digital data a respective piece of the digital file,
(ii) storing that respective piece of the digital file on the second digital data device, and
(iii) transferring the respective pieces of the digital file to the second digital data via one or more other intermediary digital devices.

2. The method of claim 1, wherein the migrating step is effected so that no respective piece of the digital file is concurrently stored on the first and second digital data devices.

3. The method of claim 1, wherein the migrating step is effected so that any same portion of the digital file that is concurrently stored on the first and second digital data devices comprises not more than an insubstantial amount of the digital data file.

4. The method of claim 1, wherein the migrating step is effected so that no respective piece of the digital file is concurrently stored on the first and second digital data devices.

5. The method of claim 1, wherein the migrating step is effected so that not more than an insubstantial amount of a creative work embodied in the digital data file is embodied in portions of the digital file that are concurrently stored on those devices.

6. The method of claim 1, wherein the respective pieces of the digital file are sized insure any of that no respective piece of the digital file is concurrently stored on the first and second digital data devices; that any same portion of the digital file that is concurrently stored on the first and second digital data devices comprises not more than an insubstantial amount of the digital data file; that no respective piece of the digital file is concurrently stored on the first and second digital data devices; and/or, that not more than an insubstantial amount of a creative work embodied in the digital data file is embodied in portions of the digital file that are concurrently stored on those devices.

7. The method of claim 1, wherein transferring step includes transferring pieces of the digital file not greater than a byte in length.

8. The method of claim 1, wherein transferring step includes transferring pieces of the digital file not greater than a digital word in length.

9. The method of claim 1, wherein transferring step includes transferring pieces of the digital file not greater than kilobyte in length.

10. The method of claim 1, including rendering substantially inaccessible, unusable and/or nullifying each respective piece of the digital file on the first digital data device in connection with transferring it to the second digital data device.

11. The method of claim 10, wherein the nullifying step includes effecting such rendering substantially inaccessible, unusable and/or nullifying of each respective piece prior to initiating its transfer to the second digital data device.

12. The method of claim 10, wherein the nullifying step includes effecting such rendering substantially inaccessible, unusable and/or nullifying of each respective piece concurrently with effecting its transfer to the second digital data device.

13. The method of claim 10, wherein the nullifying step includes effecting such rendering substantially inaccessible, unusable and/or nullifying of each respective piece subsequent to verification of its transfer to the second digital data device.

14. The method of claim 10, in which sizes of the respective pieces of the digital file and/or a timing of transfer and/or rendering substantially inaccessible, unusable and/or nullifying of the respective pieces to the second digital data device are selected to insure any of that no respective piece of the digital file is concurrently stored on the first and second digital data devices; that any same portion of the digital file that is concurrently stored on the first and second digital data devices comprises not more than an insubstantial amount of the digital data file; that no respective piece of the digital file is concurrently stored on the first and second digital data devices; and/or, that not more than an insubstantial amount of a creative work embodied in the digital data file is embodied in portions of the digital file that are concurrently stored on those devices.

15. The method of claim 1, in which the transferring step includes transferring to the second digital data patterns representing each a respective piece of the digital file.

16. The method of claim 15, in which at least such pattern includes the respective piece of the digital file, along with an error-correcting code.

17. The method of claim 15, in which at least such pattern includes a mask-encoded representation of the respective piece.

18. The method of claim 17, including randomly generating masks for use in generating the mask-encoded representations.

19. The method of claim 15, including transmitting one or more masks to the first digital data device and using those mask(s) to generate patterns from the respective pieces.

20-23. (canceled)

24. A method for the sale, (re)sale, lending, streaming or other transfer of digital media objects of digital media objects, comprising
A. storing a digital file on a first digital data device,
B. migrating that digital file to a second digital data device by repeating a plurality of times the steps of:
(i) transferring to a second digital data a respective piece of the digital file,
(ii) storing that respective piece of the digital file on the second digital data device, and
(iii) transferring, the respective pieces of the digital file to the second digital data via one or more other intermediary digital devices.

25-30. (canceled)
